(19) United States
(12) Patent Application Publication
(10) Pub. No.: US 2016/0012441 A1
(43) Pub. Date: Jan. 14, 2016

(54) METHOD AND SYSTEM FOR OPTIMIZING AUTHENTICIATION PROCESSES IN PAYMENT TRANSACTIONS

(71) Applicant: MasterCard International Incorporated, New York, NY (US)

(72) Inventors: Ina GOLDBERG, New York, NY (US); Steven Joel JONAS, Westport, CT (US)

(21) Appl. No.: 14/330,480

(22) Filed: Jul. 14, 2014

(51) Int. Cl. G06Q 20/40

(52) U.S. Cl. CPC G06Q 20/40

(57) ABSTRACT

A method for identifying a level of authentication includes: storing a plurality of authentication processes, each tool being associated with transaction characteristics; storing a plurality of account profiles, each profile including account data and an account identifier; receiving an authorization request for a payment transaction, the request including transaction data and a specific account identifier; identifying at least two eligible authentication processes based on the transaction characteristics for the respective tool and the transaction data; identifying a specific account profile that includes the specific account identifier; estimating a profitability value of the transaction based on the transaction data; estimating an account purchase elasticity value based on the account data included in the identified specific account profile; and selecting one or more authentication processes of the identified at least two eligible authentication processes based on the estimated profitability and account purchase elasticity values.

### FIELD

The present disclosure relates to the identification of a level of authentication to be used in a payment transaction, specifically the use of profitability and elasticity values for a payment transaction and involved payment account to determine the type of authentication recommended for use in the payment transaction.

### BACKGROUND

As technology increases, particularly the presence and ease of conducting transactions online via the Internet, whether personal computer-based or mobile, consumers often have a decreased tolerance for lengthy and difficult authentication processes. Merchants may be forced to either tolerate an increased number of fraudulent transactions due to using faster, less secure authentication methods, or to tolerate an increased number of lost transactions due to consumers opting to go with other merchants who have quicker, simpler authentication processes or abandoning the transaction altogether.

The purchasing experience may also greatly differ for the consumer based on the location of their merchant, particularly in an Internet-based or other type of cross-border transaction. In such instances, a merchant may be accustomed to using a specific type of authentication process, which may be typical in their country and widely accepted by consumers in that country, while the consumer may be used to quicker methods of authentication that require less time and cooperation of the consumer as is typical in their own country. The result is that the consumer may feel uncomfortable transacting with the foreign merchant and switch to a different merchant in their own country that uses a more familiar authentication process.

However, if the foreign merchant were able to use the consumer's regular, familiar authentication process, with the knowledge that the consumer would go through with the transaction and that there was a high likelihood that the transaction was trustworthy, then both the consumer and merchant may have a more pleasant and successful purchasing experience. Thus, there is a need for a technical solution to enable the selection of an authentication process for a payment transaction using profitability and elasticity.

### SUMMARY

The present disclosure provides a description of systems and methods for the identification of levels of authentication for payment transactions.

A method for identifying a level of authentication includes: storing, in a rules database, a plurality of authentication processes, wherein each authentication process is associated with one or more transaction characteristics; storing, in an account database, a plurality of account profiles, wherein each account profile includes data related to a payment account including at least account data and an account identifier; receiving, by a receiving device, an authorization request for a payment transaction, wherein the authorization request includes at least transaction data and a specific account identifier; identifying, in the rules database, at least two eligible authentication processes based on a correspondence between the one or more transaction characteristics associated with the respective authentication process and the transaction data included in the received authorization request; identifying, by a processing device, a specific account profile where the included account identifier corresponds to the specific account identifier; estimating, by the processing device, a profitability value of the transaction based on at least the transaction data included in the received authorization request; estimating, by the processing device, an account purchase elasticity value based on at least the account data included in the identified specific account profile; and selecting, by the processing device, one or more authentication processes of the identified at least two eligible authentication processes based on at least the estimated profitability value and estimated account purchase elasticity value.

A system for identifying a level of authentication includes a rules database, an account database, a receiving device, and a processing device. The rules database is configured to store a plurality of authentication processes, wherein each authentication process is associated with one or more transaction characteristics. The account database is configured to store a plurality of account profiles, wherein each account profile includes data related to a payment account including at least account data and an account identifier. The receiving device is configured to receive an authorization request for a payment transaction, wherein the authorization request includes at least transaction data and a specific account identifier. The processing device is configured to: identify, in the rules database, at least two eligible authentication processes based on a correspondence between the one or more transaction characteristics associated with the respective authentication process and the transaction data included in the received authorization request; identify a specific account profile where the included account identifier corresponds to the specific account identifier; estimate a profitability value of the transaction based on at least the transaction data included in the received authorization request; estimate an account purchase elasticity value based on at least the account data included in the identified specific account profile; and select one or more authentication processes of the identified at least two eligible authentication processes based on at least the estimated profitability value and estimated account purchase elasticity value.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying levels of authentication for payment transactions in accordance with exemplary embodiments.

FIG. 2 is a block diagram illustrating the processing server of FIG. 1 for the identification of a level of authentication in accordance with exemplary embodiments.

FIG. 3 is a flow diagram illustrating a high level process for identifying authentication processes based on an identified level of authentication using the system of FIG. 1 accordance with exemplary embodiments.

FIG. 4 is a flow diagram illustrating a process for identifying levels of authentication and corresponding authentication processes using the processing server of FIG. 2 in accordance with exemplary embodiments.

FIG. 5 is a flow chart illustrating an exemplary method for identifying a level of authentication in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Payment Account—A financial account that may be used to fund a transaction, such as a checking account, savings account, credit account, virtual payment account, etc. A payment account may be associated with a consumer, which may be any suitable type of entity associated with a payment account, which may include a person, family, company, corporation, governmental entity, etc. In some instances, a payment account may be virtual, such as those accounts operated by PayPal®, etc.

### System for Identifying Authentication Processes Based on Levels of Authentication

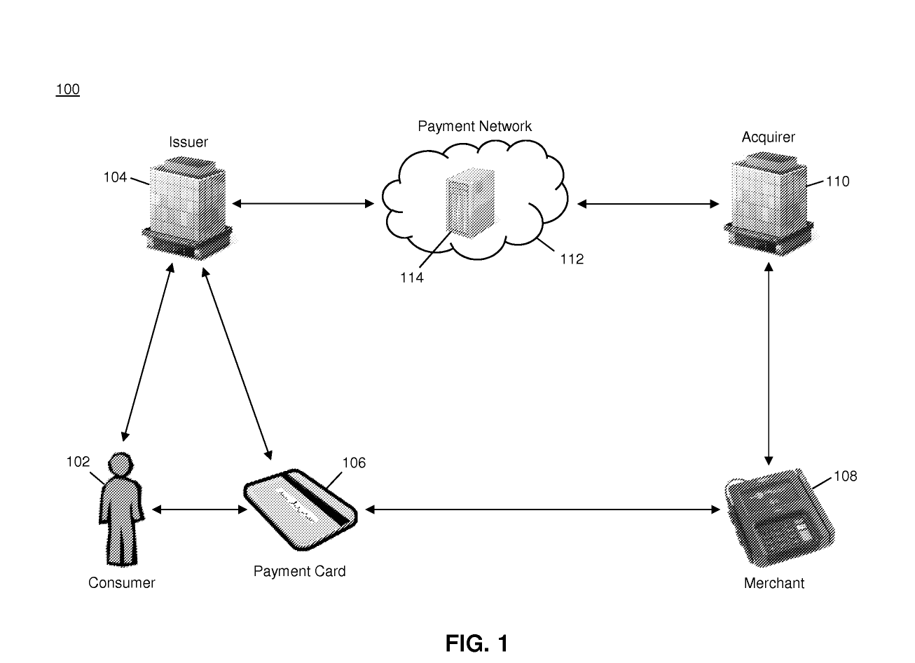

FIG. 1 illustrates a system 100 for the identification of a level of authentication for a payment transactions and subsequent identification of authentication processes for use in the payment transaction based on the level of authentication.

A consumer 102 may be a part of the system 100. The consumer 102 may have one or more payment accounts with an issuer 104. The issuer 104 may be a bank or other type of financial institution that may provide payment accounts to consumers 102 or other suitable types of entities. As part of the payment account, the issuer 104 may issue a payment card 106 to the consumer 102, such as a credit card, debit card, or other suitable type of payment card.

The consumer 102 may use their payment card 106 at the point of sale of a merchant 108 in order to fund a payment transaction involving the consumer 102 and merchant 108. In a traditional payment transaction, the merchant 108 may forward transaction data (e.g., including an amount for the payment transaction) and payment details read from the payment card 106 to an acquirer 110, such as an acquiring bank or other financial institution. The acquirer 110 may then submit an authorization request for the payment transaction to a payment network 112 for processing. The payment network 112 may process the payment transaction using traditional methods and systems that will be apparent to persons having skill in the relevant art, which may include communicating with the issuer 104 and/or acquirer 110 regarding the payment transaction and/or the consumer 102 and their payment account associated with the payment card 106 used in the payment transaction.

As part of the processing of a traditional payment account, the payment network 112, issuer 104, and/or acquirer 110 may require a specific level of authentication of the consumer 102 prior to approving the transaction. For example, some merchants 108 or acquirers 110 may require that the consumer 102 present picture identification to authenticate the consumer 102 as a person authorized to use the payment card 106 presented in the payment transaction. In another example, an issuer 104 may require that the consumer 102 provide a signature when the payment card 106 is used, in order to verify the consumer's 102 identity.

In the systems and methods disclosed herein, the payment network 112 of the system 100 may include a processing server 114. The processing server 114, discussed in more detail below, may be configured to identify a level of authentication to be used in a payment transaction conducted between the consumer 102 and the merchant 108, and may select one or more authentication processes to recommend to the acquirer 110, issuer 104, and/or merchant 108 to be used to authenticate the consumer 102 based on the identified level of authentication.

As discussed in more detail below, the processing server 114 may receive transaction data for the payment transaction from the acquirer 110 and may also store account data related to the payment account associated with the payment card 106 (e.g., received from the issuer 104). The processing server 114 may estimate a profitability value for the payment transaction, which may represent the potential gains of the merchant 108 for the transaction and potential future transactions. In some instances, the processing server 114 may also, or alternatively, estimate a profitability value that represents potential gains for the payment network 112, issuer 104, and/or acquirer 110. The processing server 114 may also estimate an elasticity value of the consumer 102, which may represent the tolerance of the consumer 102 for various authentication procedures or authentication processes. The processing server 114 may then identify one or more authentication processes to be used based on the profitability of the transaction and the elasticity of the consumer 102.

For example, if the processing server 114 identifies that a transaction has a high profitability, and that the consumer 102 has a low tolerance for authentication procedures, the processing server 114 may recommend authentication processes related to a low level of authentication to the merchant 108, in order to encourage the consumer 102 to carry out the transaction in the hopes of future business due to the high profitability. Conversely, if the transaction has a low profitability, the processing server 114 may recommend authentication processes related to a medium or high level of authentication, despite the consumer's 102 preference, as a combination of the desire to prevent fraud and the low profitability of the transaction may outweigh the consumer's 102 likelihood to abandon the transaction in the face of a higher level of authentication.

In some embodiments, the authentication processes recommended to the issuer 104, acquirer 110, and/or merchant 108 may be based on preferences of the respective entity. For example, the processing server 114 may identify a different value of profitability for the issuer 104 and the acquirer 110, and may thereby recommend different authentication procedures to each entity. In another example, the processing server 114 may recommend different levels of authentication based on the issuer 104 and acquirer 110 involved in particular transaction, such as due to each entity's tolerance for potential fraud, fraud prevention capabilities, and supported authentication processes. Additional basis for the selection of authentication processes using transaction profitability and consumer elasticity will be apparent to persons having skill in the relevant art.

Once the processing server 114 has recommended one or more authentication processes to the issuer 104, acquirer 110, and/or merchant 108, the respective entities may select authentication processes to use in the payment transaction based on the recommendation. The consumer 102 may then be authenticated using the selected authentication processes, and the transaction processed using traditional methods and systems. In some embodiments, the processing server 114 may provide the profitability and/or elasticity values to an entity involved in the transaction, for the respective entity to use to select authentication processes themselves.

The use of profitability values specific to a transaction and elasticity values specific to a consumer 102 involved in a transaction may result in the processing server 114 being able to recommend authentication processes that can provide for an increased rate of success in payment transactions in terms of both consumer retention and fraud prevention. By selecting authentication processes more amenable to a consumer 102, the likelihood that the consumer 102 will complete the transaction may be increased. In addition, by selecting authentication processes based on profitability of the transaction, particularly if future profitability based on the consumer 102 is also considered, merchants 108 and acquirers 110 may accommodate consumers 102 that they otherwise may not have, which may result in increased revenue for both the initial transactions and future transactions with the consumers 102.

### Processing Server

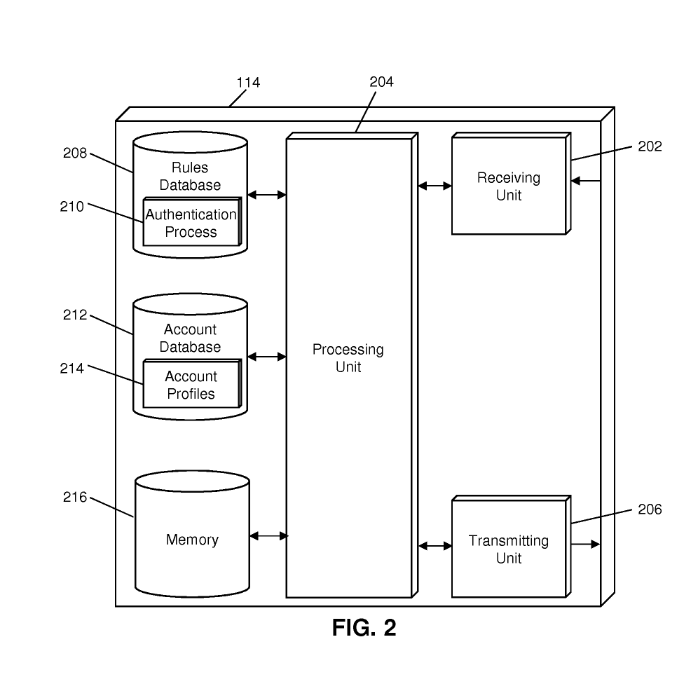

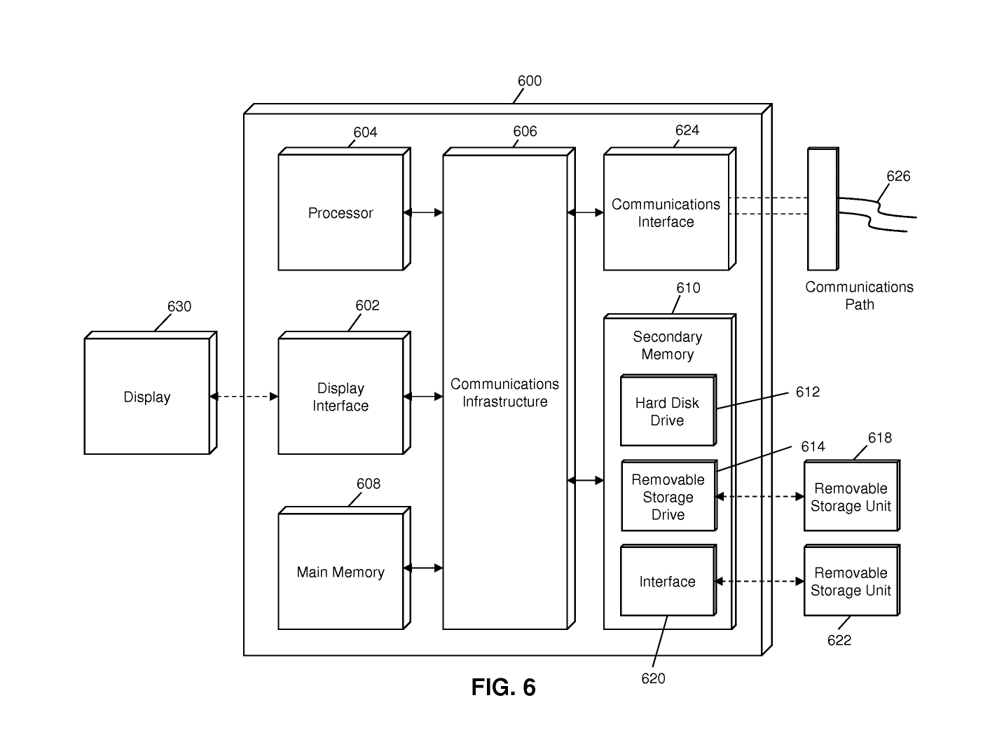

FIG. 2 illustrates an embodiment of the processing server 114 of the system 100. It will be apparent to persons having skill in the relevant art that the embodiment of the processing server 114 illustrated in FIG. 2 is provided as illustration only and may not be exhaustive to all possible configurations of the processing server 114 suitable for performing the functions as discussed herein. For example, the computer system 600 illustrated in FIG. 6 and discussed in more detail below may be a suitable configuration of the processing server 114.

The processing server 114 may include a rules database 208. The rules database 208 may be configured to store a plurality of authentication processes 210. Each authentication process 210 may be associated with one or more transaction characteristics. The transaction characteristics may include a payment account number or identifier, account data, a merchant identifier, an issuer identifier, a geographic location, a transaction amount, a transaction time and/or date, or any other suitable characteristic. The one or more transaction characteristics may be such that the associated authentication process 210 may be applicable to payment transactions having those characteristics. For example, an authentication process associated with a particular merchant identifier may only be applicable to payment transactions involving the merchant 108 related to that particular merchant identifier.

The processing server 114 may also include an account database 212. The account database 212 may be configured to store a plurality of account profiles 214. Each account profile 214 may include data related to a payment account and may include at least account data and an account identifier. The account identifier may be an account number for the related payment account, an identification value, an identifier of the consumer 102 associated with the related payment account, a username, an e-mail address, a telephone number, or other suitable value used for identification of an account profile 214. The account data may include data associated with the related payment account, including transaction data for payment transactions involving the related payment account, account elasticity history, authentication history, consumer preferences, etc.

The processing server 114 may also include a receiving unit 202. The receiving unit 202 may be configured to receive data over one or more networks via one or more network protocols. The receiving unit 202 may receive account data from the issuer 104 for one or more payment accounts, which may be stored in the corresponding account profiles 214 in the account database 212. The receiving unit 202 may also be configured to receive authorization requests for payment transactions, such as from the acquirer 110. Each authorization request may include at least transaction data and an account identifier. The transaction data may include a merchant identifier, consumer data, product data, point of sale data, a transaction amount, a transaction time and/or date, a geographic location, and any other suitable data as will be apparent to persons having skill in the relevant art.

The processing server 114 may further include a processing unit 204. The processing unit 204 may be configured to perform the functions disclosed herein as will be apparent to persons having skill in the relevant art. The processing unit 204 may be configured to identify a specific account profile 214 that includes the account identifier included in an authorization request received by the receiving unit 202. The processing unit 204 may be further configured to identify two or more eligible authentication processes 210 stored in the rules database 208 based on the transaction characteristics associated with each respective authentication process 210 and the transaction data included in the received authorization request.

The processing unit 204 may also be configured to estimate a profitability value for the payment transaction based on at least the transaction data included in the received authorization request. In some embodiments, the profitability value may be further based on the issuer 104 associated with the payment account used in the payment transaction, the payment card 106 used in the payment transaction (e.g., debit, credit, etc.), the acquirer 110 and/or merchant 108 involved in the payment transaction, the cross border corridor if the payment transaction is a cross-border payment transaction, account data stored in the identified account profile 214 (e.g., past transaction history, estimated future transactions, etc.), and additional criteria that will be apparent to persons having skill in the relevant art.

The processing unit 204 may be further configured to estimate an account purchase elasticity value for the identified specific account profile 214. The account purchase elasticity value may be based on at least the account data included in the specific account profile 214, the transaction data for the payment transaction, the issuer 104, the acquirer 110, the merchant 108, past account elasticity values, past account authentication procedures, consumer preferences, consumer feedback, behavior by similar consumers, market research, business rules, etc.

The processing unit 204 may also be configured to select one or more authentication processes 210 from the identified eligible authentication processes 210 based on the estimated profitability and account purchase elasticity values. As discussed above, the processing unit 204 may select one or more authentication processes 210 to recommend to the issuer 104, acquirer 110, merchant 108, and/or any other entity that may be involved in the payment transaction, based on weighing of the estimated profitability (e.g., present and future) of the transaction, elasticity of the consumer 102 involved in the transaction, the entity to which the recommendation is being made, and any other suitable criteria.

The processing server 114 may further include a transmitting unit 206. The transmitting unit 206 may be configured to transmit data over one or more networks via one or more network protocols. The transmitting unit 206 may transmit a recommendation of the one or more selected authentication processes 210 to the appropriate entity, such as the issuer 104, acquirer 110, and/or merchant 108. In some embodiments, the recommendation may include the estimated profitability value and/or account elasticity value.

The processing server 114 may also include a memory 216. The memory 216 may be configured to store data suitable for performing the functions disclosed herein as will be apparent to persons having skill in the relevant art. The memory 216 may store, for example, algorithms suitable for selecting authentication processes 210 from eligible authentication processes based on estimated profitability and account elasticity values.

In some embodiments, the components of the processing server 114 may be configured to perform the traditional functions of the payment network 112, such as the processing of payment transactions. For example, the receiving unit 202 may receive transaction authorizations from issuers 104, the processing unit 204 may process payments based on authorized transactions, and the transmitting unit 206 may transmit authorization response to acquirers 110 and/or merchants 108. Additional functions performed by the components of the processing server 114 for the processing of payment transactions using traditional methods will be apparent to persons having skill in the relevant art.

In some instances, the processing unit 204 may be further configured to calculate a cutoff score for the payment transaction. The cutoff score may be based on at least one of: the estimated profitability value, the estimated account purchase elasticity value, and the transaction data for the payment transaction. In such an instance, the cutoff score may be used in a determination for the payment network 112 to stand in for the payment transaction in instances where the issuer 104 may decline authorization for the transaction. For example, the issuer 104 may decline authorization of a transaction due to a low level of authentication processes used by the merchant 108 (e.g., due to a consumer's 102 low elasticity), but the payment network 112 may stand in as the issuer 104 for the transaction if the profitability value is sufficient such that the cutoff score is above a predetermined threshold. Additional criteria for deciding to stand in for a payment transaction by a payment network 112 will be apparent to persons having skill in the relevant art.

### Process for Identifying and Recommendation an Authentication Level

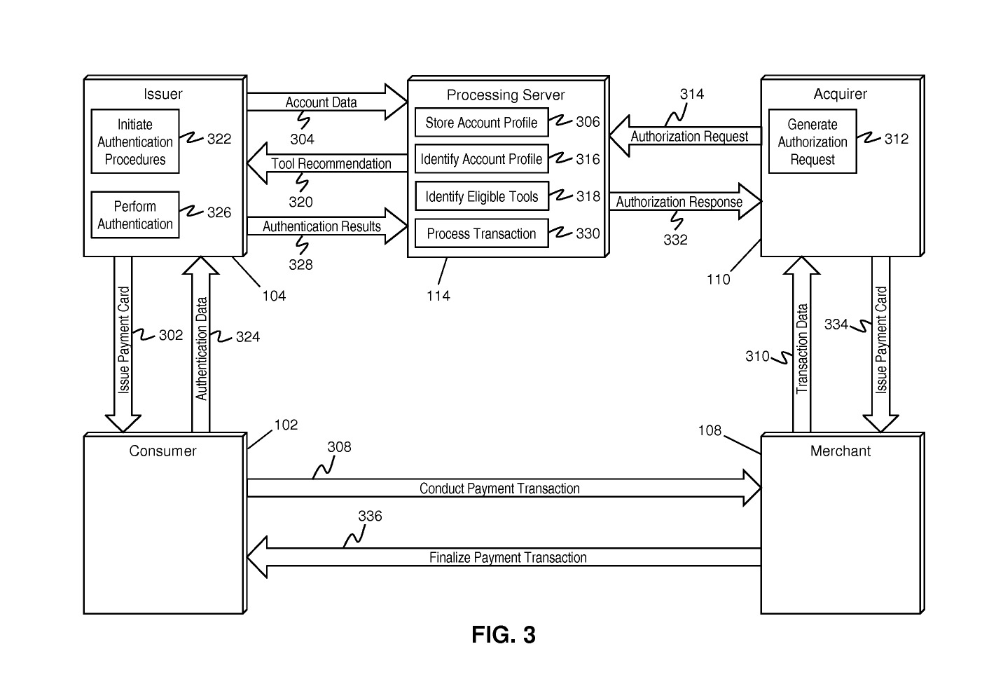

FIG. 3 illustrates a process for the identification of an authentication level and subsequent recommendation of authentication processes 210 for use in authenticating a consumer 102 in a payment transaction.

In step 302, the issuer 104 may issue a payment card 106 to the consumer 102 on a payment account held by the consumer 102 with the issuer 104. In step 304, the issuer 104 may transmit account data associated with the payment account for which the payment card 106 was issued to the processing server 114. The receiving unit 202 of the processing server 114 may receive the account data, and, in step 306, the processing unit 204 of the processing server 114 may store the account data in a corresponding account profile 214 in the account database 212.

In step 308, the consumer 102 may conduct a payment transaction with the merchant 108, which may include presenting the issued payment card 106 to the merchant 108 for funding of the payment transaction. In step 310, the point of sale system of the merchant 108 may transmit transaction data for the payment transaction, including payment details read from the payment card 106, to the acquirer 110. In step 312, the acquirer 110 may generate an authorization request for the payment transaction including the received transaction data using methods that will be apparent to persons having skill in the relevant art.

In step 314, the authorization request may be submitted to the processing server 114 by the acquirer 110. The receiving unit 202 of the processing server 114 may receive the request, and then, in step 316, the processing unit 204 may identify the account profile 214 stored in the account database 212 corresponding to the payment account associated with the payment card 106 used in the transaction, based on the payment details (e.g., an account identifier) included in the authorization request.

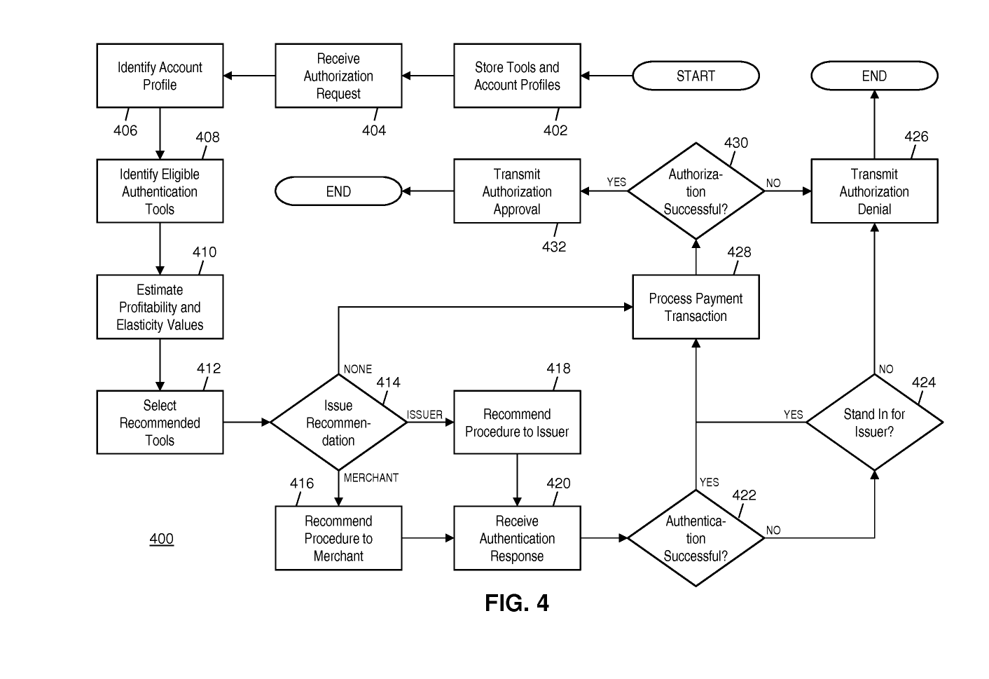

In step 318, the processing unit 204 may identify two or more eligible authentication processes 210 stored in the rules database 208 based on the associated one or more transaction characteristics and the transaction data included in the received authorization request. The transaction characteristics and/or transaction data may include, for example, issuer data, acquirer data, merchant data, transaction amounts, geographic location of the consumer 102, merchant 108, acquirer 110, and/or issuer 104, transaction times and/or dates, and any other suitable data. The processing unit 204 may then select one or more authentication processes 210 from the identified eligible authentication processes 210 to recommend to the issuer 104 based on an estimated profitability value for the transaction and an estimated account elasticity value, such as estimated using the method 400 illustrated in FIG. 4 and discussed in more detail below.

In step 320, the transmitting unit 206 of the processing server 114 may transmit the recommended one or more authentication processes 210 to the issuer 104. In step 322, the issuer may initiate authentication procedures based on the recommended authentication processes 210, such as by using each of the one or more tools 210 recommended by the processing server 114. It will be apparent to persons having skill in the relevant art that, in some instances, the authentication procedures may be initiated by the acquirer 110 and/or merchant 108, and may further be requested by the issuer 104 based on the recommendation.

In step 324, the consumer 102 may provide authentication data to the issuer 104 as pursuant to the initiated authentication procedures, such as by providing a signature, personal identification number, picture identification, password, geolocation data, etc. In step 326, the issuer 104 may authenticate the consumer 102 using the authentication data using methods and systems that will be apparent to persons having skill in the relevant art. In step 328, the issuer 104 may provide the authentication results (e.g., successful or unsuccessful authentication) to the processing server 114.

The receiving unit 202 of the processing server 114 may receive the results and then, in step 330, the processing unit 204 may process the transaction accordingly. In some embodiments, if the authentication results indicate that authentication was unsuccessful and the issuer 104 denies the transaction, the processing unit 204 may calculate a cutoff score and make a determination to stand-in for the issuer 104 in the payment transaction, based on the calculated cutoff score. In such an embodiment, the processing of the payment transaction in step 330 may include processing the payment transaction with the payment network 112 taking place of the issuer 104, and approving or denying the transaction accordingly.

In step 332, the transmitting unit 206 of the processing server 114 may transmit an authorization response to the acquirer 110 indicating approval or denial of the payment transaction based on the transaction processing. In step 334, the acquirer 110 may forward the authorization response to the merchant 108. In step 336, the merchant 108 may finalize the transaction with the consumer 102 accordingly, based on the authorization response, such as by furnishing a receipt and the transacted-for goods or services to the consumer 102 if the transaction was approved, or by informing the consumer 102 that the transaction cannot be completed if the transaction was denied.

### Process for Identifying an Authentication Level and Recommending Authentication Processes

FIG. 4 illustrates a process 400 for the identification of an authentication level and subsequent selection and recommendation of authentication processes for use in processing a payment transaction.

In step 402, authentication processes 210 and account profiles 214 may be stored in the rules database 208 and account database 212 of the processing server 114, respectively. Each authentication process 210 may be associated with one or more transaction characteristics, and each account profile may include an account identifier and account data associated with a related payment account. In step 404, the receiving unit 202 of the processing server 114 may receive an authorization request for a payment transaction, the authorization request including transaction data and a specific account identifier.

In step 406, the processing unit 204 of the processing server 114 may identify a specific account profile 214 that includes an account identifier that corresponds to the specific account identifier included in the received authorization request. In step 408, the processing unit 204 may identify two or more eligible authentication processes 210 stored in the rules database based on at least the transaction data included in the received authorization request. In some embodiments, the eligible authentication processes 210 may be further based on the account data stored in the specific account profile 214 or other suitable data.

In step 410, the processing unit 204 may estimate a profitability value for the payment transaction based on at least the transaction data included in the received authorization request, and an account elasticity value based on at least the account data included in the specific consumer profile 214. In some instances, the profitability value may be further based on account data included in the specific consumer profile 214, merchant data, issuer data, data regarding other consumers 102 and/or account profiles 214, etc. For example, the profitability may include data regarding future profitability, which may be based on transaction data regarding similar (e.g., based on demographics, purchase behavior, etc.) accounts. In some instances, the account elasticity value may be further based on the transaction data included in the received authorization request, merchant data, issuer data, geographic location, etc. In one embodiment, the account elasticity value may be based on historical elasticity data associated with the specific account profile 214, such as included in the account data.

In step 412, the processing unit 204 may select one or more authentication processes 210 to recommend based on the estimated profitability and elasticity values. In step 414, the processing unit 204 may determine if a recommendation is to be made for the selected one or more authentication processes 210, and to whom the recommendation should be made. If the recommendation is to be made to the merchant 108, then, in step 416, the transmitting unit 206 of the processing server 114 may transmit the recommended one or more authentication processes to the merchant 108. If the recommendation is to be made to the issuer 104, then the transmitting unit 206 may transmit the recommended one or more authentication processes to the issuer 104.

In step 420, the receiving unit 202 may receive an authentication response from the merchant 108 or issuer 104. In step 422, the processing unit 204 may determine if the authentication was successful or not based on the received authentication response. If the authentication was not successful, then, in step 424, the processing unit 204 may determine if the payment network 112 is to stand in for the issuer 104 and approve the transaction in place of the issuer 104. In some instances, the determination may include calculating a cutoff score based on the transaction data, estimated profitability value, and/or estimated account elasticity value, and deciding to stand in and subsequently approve or deny the payment transaction based on the calculated cutoff score. Additional steps that may be performed in the determination of whether a payment network 112 may stand in for an issuer 104 will be apparent to persons having skill in the relevant art. If the payment network 112 is not to stand in for the issuer 104, then, in step 426, the transmitting unit 206 may transmit an authorization response indicating denial of the payment transaction to the acquirer 110 and/or merchant 108.

If the payment network 112 is to stand in for the issuer 104, if the authentication in step 422 was successful, or if authentication was not performed (e.g., no recommendation was issued based on the decision in step 414), then, in step 428, the processing unit 204 may process the payment transaction using methods and systems that will be apparent to persons having skill in the relevant art.

As part of the processing of the payment transaction, in step 430 the processing unit 204 may determine if authorization of the payment transaction was successful, such as based on a response received from the issuer 104. If the authorization was successful, then, in step 432, the transmitting unit 206 may transmit an authorization response indicating approval of the transaction to the acquirer 110 and/or merchant 108. If the authorization was unsuccessful, then, in the process 400 may return to step 426, where the transmitting unit 206 may transmit an authorization response indicating denial of the transaction to the acquirer 110 and/or merchant 108.

### Exemplary Method for Identifying a Level of Authentication

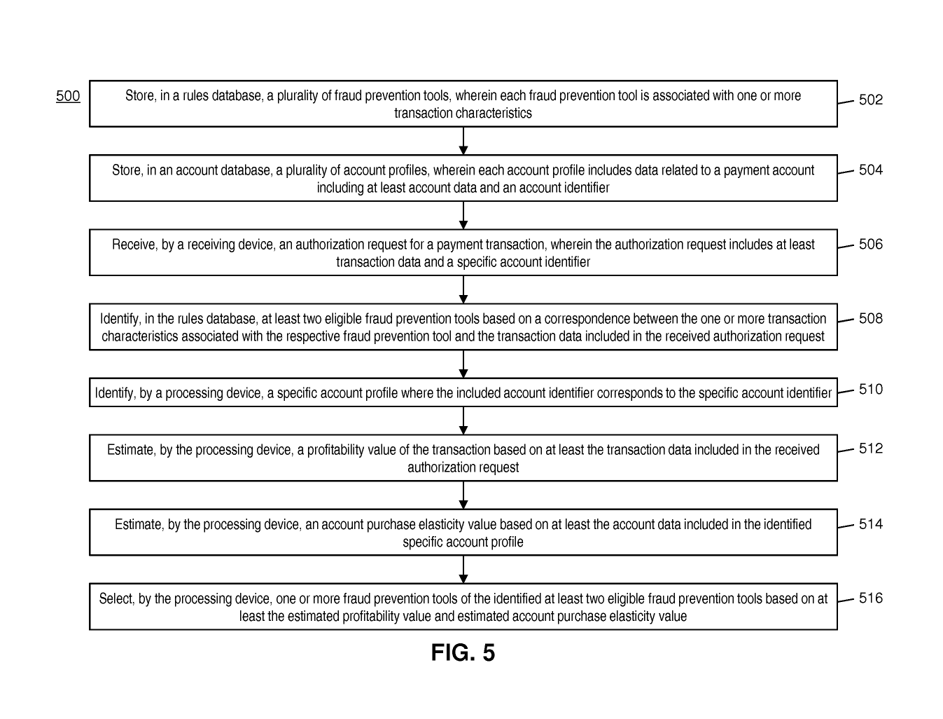

FIG. 5 illustrates a method 500 for identifying a level of authentication including the selection of fraud prevention based on estimated profitability and account elasticity values.

In step 502, a plurality of authentication processes (e.g., authentication processes 210) may be stored in a rules database (e.g., the rules database 208), wherein each authentication process is associated with one or more transaction characteristics. In some embodiments, the transaction characteristics may include at least one of: a payment account, an account identifier, account data, a merchant identifier, an issuer identifier, a geographic location, a transaction amount, and a transaction time and/or date. In some embodiments, each authentication process 210 may be associated with one or more rules regarding usage of the associated authentication process 210, such as based on legislative permissiveness of the authentication process 210.

In step 504, a plurality of account profiles (e.g., account profiles 214) may be stored in an account database (e.g., the account database 212), wherein each account profile 214 includes data related to a payment account including at least account data and an account identifier. In some embodiments, the account data may include transaction data for a plurality of payment transactions involving the related payment account. In step 506, an authorization request for a payment transaction may be received by a receiving device (e.g., the receiving unit 202), wherein the authorization request includes at least transaction data and a specific account identifier. In some embodiments, the transaction data may include at least one of: a merchant identifier, consumer data, product data, point of sale data, a transaction amount, a transaction time and/or date, and a geographic location.

In step 508, at least two eligible fraud prevention rules 210 may be identified in the rules database 208 based on a correspondence between the one or more transaction characteristics associated with the respective authentication process 210 and the transaction data included in the received authorization request. In step 510, a specific account profile 214 may be identified by a processing device (e.g., the processing unit 204) where the included account identifier corresponds to the specific account identifier.

In step 512, a profitability value of the transaction may be estimated by the processing device 204 based on at least the transaction data included in the received authorization request. In one embodiment, the profitability value is further based on the account data included in the identified specific account profile 214. In a further embodiment, the profitability value may be represented as a score of past performance and predicted future performance of the payment account related to the identified specific account profile 214.

In step 514, an account purchase elasticity value may be estimated by the processing device 504 based on at least the account data included in the identified specific account profile. In some embodiments, the account data may include at least account elasticity history for a plurality of payment transactions involving the related account, and the estimated account purchase elasticity value may be based on the account elasticity history included in the identified specific account profile. In one embodiment, the account purchase elasticity value may be based on historical data regarding account elasticity and transaction outcomes for past transactions. In a further embodiment, the past transactions may involve the same or similar payment accounts as involved in the payment transaction.

In step 516, one or more authentication processes 210 of the identified at least two eligible authentication processes 210 may be selected, by the processing device 204, based on at least the estimated profitability value and estimated account purchase elasticity value. In one embodiment, the method 500 may further include calculating, by the processing device 204, a cutoff score based on at least the estimated profitability value, the estimated account purchase elasticity value, and the transaction data included in the received authorization request. In another embodiment, the method 500 may also include transmitting, by a transmitting device (e.g., the transmitting unit 206), at least the authorization request and the selected one or more fraud prevention rules 210. In a further embodiment, the authorization request and the selected one or more fraud prevention rules 210 may be transmitted to at least one of: an issuer (e.g., the issuer 104) associated with the payment account related to the identified specific account profile 214 and a merchant (e.g., the merchant 108) involved in the payment transaction.

### Computer System Architecture

FIG. 6 illustrates a computer system 600 in which embodiments of the present disclosure, or portions thereof, may be implemented as computer-readable code. For example, the processing server 114 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for identifying levels of authentication and selecting authentication processes. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a level of authentication, comprising:
storing, in a rules database, a plurality of authentication processes, wherein each authentication process is associated with one or more transaction characteristics;
storing, in an account database, a plurality of account profiles, wherein each account profile includes data related to a payment account including at least account data and an account identifier;
receiving, by a receiving device, an authorization request for a payment transaction, wherein the authorization request includes at least transaction data and a specific account identifier;
identifying, in the rules database, at least two eligible authentication processes based on a correspondence between the one or more transaction characteristics associated with the respective authentication process and the transaction data included in the received authorization request;
identifying, by a processing device, a specific account profile where the included account identifier corresponds to the specific account identifier;
estimating, by the processing device, a profitability value of the transaction based on at least the transaction data included in the received authorization request;
estimating, by the processing device, an account purchase elasticity value based on at least the account data included in the identified specific account profile; and
selecting, by the processing device, one or more authentication processes of the identified at least two eligible authentication process based on at least the estimated profitability value and estimated account purchase elasticity value.

2. The method of claim 1, further comprising:
calculating, by the processing device, a cutoff score based on at least the estimated profitability value, the estimated account purchase elasticity value, and the transaction data included in the received authorization request.

3. The method of claim 1, further comprising:
transmitting, by a transmitting device, at least the authorization request and the selected one or more authentication processes.

4. The method of claim 3, wherein the authorization request and the selected one or more fraud prevention rules are transmitted to at least one of: an issuer associated with the payment account related to the identified specific account profile and a merchant involved in the payment transaction.

5. The method of claim 1, wherein the profitability value is further based on the account data included in the identified specific account profile.

6. The method of claim 5, wherein the profitability value is represented as a score of past performance and predicted future performance of the payment account related to the identified specific account profile.

7. The method of claim 1, wherein the account data includes transaction data for a plurality of payment transactions involving the related payment account.

8. The method of claim 1, wherein the transaction characteristics include at least one of: a payment account, an account identifier, account data, a merchant identifier, an issuer identifier, a geographic location, a transaction amount, and a transaction time and/or date.

9. The method of claim 1, wherein the transaction data includes at least one of: a merchant identifier, consumer data, product data, point of sale data, a transaction amount, a transaction time and/or date, and a geographic location.

10. The method of claim 1, wherein the account data includes at least account elasticity history for a plurality of payment transactions involving the related account, and wherein the account purchase elasticity value is based on at least the account elasticity history included in the identified specific account profile.

11. A system for identifying a level of authentication, comprising:
a rules database configured to store a plurality of authentication processes, wherein each authentication process is associated with one or more transaction characteristics;
an account database configured to store a plurality of account profiles, wherein each account profile includes data related to a payment account including at least account data and an account identifier;
a receiving device configured to receive an authorization request for a payment transaction, wherein the authorization request includes at least transaction data and a specific account identifier; and
a processing device configured to
identify, in the rules database, at least two eligible authentication processes based on a correspondence between the one or more transaction characteristics associated with the respective authentication process and the transaction data included in the received authorization request,
identify a specific account profile where the included account identifier corresponds to the specific account identifier,
estimate a profitability value of the transaction based on at least the transaction data included in the received authorization request,
estimate an account purchase elasticity value based on at least the account data included in the identified specific account profile, and
select one or more authentication processes of the identified at least two eligible authentication processes based on at least the estimated profitability value and estimated account purchase elasticity value.

12. The system of claim 11, wherein the processing device is further configured to calculate a cutoff score based on at least the estimated profitability value, the estimated account purchase elasticity value, and the transaction data included in the received authorization request.

13. The system of claim 11, further comprising:
a transmitting device configured to transmit at least the authorization request and the selected one or more fraud prevention rules.

14. The system of claim 13, wherein the authorization request and the selected one or more fraud prevention rules are transmitted to at least one of: an issuer associated with the payment account related to the identified specific account profile and a merchant involved in the payment transaction.

15. The system of claim 11, wherein the profitability value is further based on the account data included in the identified specific account profile.

16. The system of claim 15, wherein the profitability value is represented as a score of past performance and predicted future performance of the payment account related to the identified specific account profile.

17. The system of claim 11, wherein the account data includes transaction data for a plurality of payment transactions involving the related payment account.

18. The system of claim 11, wherein the transaction characteristics include at least one of: a payment account, an account identifier, account data, a merchant identifier, an issuer identifier, a geographic location, a transaction amount, and a transaction time and/or date.

19. The system of claim 11, wherein the transaction data includes at least one of: a merchant identifier, consumer data, product data, point of sale data, a transaction amount, a transaction time and/or date, and a geographic location.

20. The system of claim 11, wherein the account data includes at least account elasticity history for a plurality of payment transactions involving the related account, and wherein the account purchase elasticity value is based on at least the account elasticity history included in the identified specific account profile.
